(19) United States
(12) Patent Application Publication
(10) Pub. No.: US 2006/0282426 A1
(43) Pub. Date: Dec. 14, 2006

(54) Method and system for matching users for relationships using a discussion based approach

(76) Inventor: Mine Spears, Santa Monica, CA (US)

Correspondence Address: Mine Spears, PO Box 1037, Santa Monica, CA, 90406, US

(21) Appl. No.: 11/151,473

(22) Filed: Jun. 13, 2005

(51) Int. Cl. G06F 17/30

(52) U.S. Cl. 707/5

(57) ABSTRACT

A system of matching users for relationships based upon both user provided profile information, and preferences they develop as they participate in discussion forums. User profile information can be used to determine the universe of users who have mutually compatible relationship criteria, but not necessarily the actual pairs of users who have the best chance of a successful relationship. The invention introduces the concept of discussion-based matching, wherein users interact in online forums to discuss topics of interest to them. The system informs users about which other users in the discussion are potential matches. As they interact, they begin to narrow down the universe of compatible matches to a smaller set of users who they have observed or interacted with in the discussion forum. This eases the transition to private communication, which is necessary for a personal relationship to begin, and results in more successful relationships. The system also regulates abusive or rude users in the online forums by allowing other users to report such behavior. The system records these reports and can automatically take punitive action against offending users, such as displaying a list of offending users, displaying special icons next to those user's usernames, and ultimately blocking a user from accessing the system.

### CROSS-REFERENCE TO RELATED PATENT APPLICATION This application claims the benefit of PPA Ser. No. 60/578916, filed 2004 Jun. 10 by the present inventor.

### BACKGROUND—FIELD OF THE INVENTION

The invention relates generally to the operation of an online dating and friend making service. Specifically, the invention relates to a discussion based matching system whereby users may get to know one another online prior to pursuing dating and/or friendship relationships.

### BACKGROUND—DESCRIPTION OF PRIOR ART

Online dating and friend making services on the World Wide Web have proliferated in recent years. A primary goal of these services is to help users find other users with whom they are compatible, such that an enduring romantic or friendship relationship may be formed. Prior art systems have attempted to achieve this goal by first helping the users to identify other users who are potential matches, and second by enabling communication between a first user and a second user for the purpose of starting a relationship. Potential match identification in prior art systems has employed the following techniques:
1) Allowing each user to record profile information about themselves, including such things as their birth date, gender, their photograph, a personal text and/or voice message, geographic location, and other personal characteristics, as well as the criteria for the type of relationship they are seeking, including attributes of the other users they are seeking to meet. Prior art matching systems, such as that described in U.S. Pat. No. 6,249,282, use this information to conduct a search for potential matches, and allow the user to access the resulting list of matching users.
2) Allowing each user to perform online personality and/or psychological profile tests, the results of which are recorded by the matching system. Prior art systems, such as that described in U.S. Pat. No. 6,735,568, use the results of said tests as a basis for identifying potential matches. The matching system then provides the matching results to users, allowing them to look through lists of potential matches.

Once a user has access to a list of potential matches, the user takes the initiative of contacting a second user from the list, for the purpose of establishing a relationship. The following communication mechanisms have been employed in prior art systems:
1) Allowing a user to asynchronously send text, voice, video or graphical messages to another user, who is a potential match via email, or via a mechanism provided by the matching service, such as a local “inbox”. Then allowing the second user to respond in a like manner, so that a two-way communication is established whereby the two users may begin to establish a relationship.
2) Allowing two users who are simultaneously accessing the system to establish a real time, instant messaging, voice, or voice and video communications session to begin the process of establishing a relationship.

While these prior art techniques can be successful, they do suffer from a number of disadvantages, as enumerated below:
1) While user profiles containing personal information and relationship criteria are a necessary part of any matching system, they provide only a limited description of the user, and can be misleading, depending on how the user answered the questions. Many users dislike the free form text or voice entry portion of personal profiles where they are encouraged to describe themselves, as well as their ideal relationship match. They may have difficulty formulating adequate and accurate descriptions, or may be uncomfortable sharing personal details in this way. In fact, many personal messages start with a phrase similar to “I don't know what to say . . . ”. On the other hand, some users may give an overly flattering description of themselves, possibly fabricating details to enhance the image they are projecting. These factors greatly reduce the value of these profiles for the purpose of finding a potential relationship.
2) They do not provide an adequate mechanism by which users may get to learn about each other's personalities in a pressure free, non-intimidating environment, and then use this learned knowledge to make decisions regarding which users they wish to pursue romantic or friendship relationships with.
3) They require that a user initiate contact with, or accept initial contact from, another user, for whom they have little or no historical knowledge, except for what was provided in the user's profile. To some users this initial contact with someone who is essentially a stranger may prove uncomfortable and awkward. This can cause users to limit the number of contacts they initiate and accept.
4) They do not allow prospective partners to observe each other in a social setting to see how he or she behaves around others prior to starting a relationship. In offline relationships, which evolve to romantic love gradually, we usually have the opportunity to observe our future partner in a variety of settings, communicating with others, and handling different situations. We base part of our opinion of him or her on how he or she acts in these situations.
5) They often have characteristics similar to looking for merchandise in a store, or shopping through a catalog, rather than meeting a human being. Paging through people's profiles and pictures becomes similar to going through racks of clothing in a department store. Since there may be thousands of profiles to look through, users get used to the quick process of elimination without too much thought about the overall person, and quite possibly missing out on many good men and women who should be worthy of their attention. This type of environment may also be damaging to the user who is doing the “shopping”. As author Aaron Ben-Ze'ev (2004) asserts: “The frequent presence of such degrading attitudes and behavior may become deeply rooted in the personality of the individual in such a way that it may damage his or her future romantic relationships” (p. 131; “Online Love” 2004, by Aaron Ben-Ze'ev, Cambridge University Press, Cambridge, UK, incorporated herein by reference as if restated in full.)
6) They may result in placing undue importance to a person's outward appearance or other physical attributes as shown in their online photograph, or the sound of their voice. Inward qualities such as sense of humor, sensitivity, kindness, and intelligence may still be important to the user seeking a relationship, but by focusing on the online photograph many users eliminate others who may not have the ideal physical appearance they are looking for, but who do possess the inward qualities that are important for enduring love.
7) The day-to-day use of prior art matching services is not viewed as an enjoyable activity that one might spend considerable free time on. It is more of a shopping experience rather than as something to spend time on due to compelling content and interactive features.

Additionally, there is another form of prior art that can result in formation of relationships, although it was not designed or intended for that purpose. These are online discussion forums where a variety of topics are posted and commented on by a user community. The disadvantage of these prior art systems for the purpose of finding romantic and friendship relationships are as follows:
1) None are designed to also include detailed personal profiles and relationship seeking preferences. Hence, there is no way for the system itself to assist a user in determining what other users may be potential relationship matches. For example, without age related information in the user profile, a twenty-year-old user may become romantically interested in another user, only to find out later that the other user is seventy-five years old, and not a viable match. Or, users may discover that they are geographically separated such that an offline relationship is not possible.
2) The user community will invariably include many users who are not using the forum as a mechanism for finding a relationship. For example, there may be a number of happily married persons communicating on the forum because of their interest in the topics being discussed. This means that a user who is seeking a relationship is taking a much higher risk of rejection when attempting to initiate a relationship with another user.
3) Some users can be disruptive both with the language they use and the attitudes and opinions they express. They may also attempt to control others. In the online world these people are commonly known as “trolls”. Some of them can also be described as “sycophants”. The latter is a servile self-seeking flatterer who will agree with you not necessarily because she or he believes in what you say but for selfish reasons, such as gaining allies. As Dale Carnegie (“How to win Friends and Influence People”, 1990) wrote, the law to make people like you is to always make the other person feel important. Sycophants operate on this principle, and heap on the insincere flattery. Sycophants are present in everyday life also, but they are harder to detect online because you are limited to what you know about a person based on what they choose to type into their computer. You may believe they are genuine at first. It may take a significant amount of time to catch on to their deceptive behavior. Their insincere attitude is especially unwelcome in discussion-based forums where users expect others to express honestly held opinions. The anonymity of computer-based communication can contribute to this problem, because it causes some users to act worse then they would have if their true identity were known. Angry personalities frequently take over Internet newsgroups, acting as if they own the forum. One way they have been combated in the past is with moderated groups, where a moderator reads all posts and can delete or edit inappropriate material. However, this approach is time consuming and costly.

### SUMMARY OF THE INVENTION

The present invention is a matching system that solves the problems of the prior art by combining traditional matching service features with asynchronous online discussion forums wherein multiple users can communicate in group-wide discussions on topics of interest. First, users register with the matching system, providing personal profile information including their traits, and relationship preferences. Then, they begin to participate in the online discussion forums by asynchronously posting new topics for discussion, as well as commentary on existing topics. As they do so, they learn which other users they are most interested in by observing their online behavior. For example, a user may determine a set of other users with whom they hold similar religious or political views based on the comments that those other users have made on religious and political topics. The matching system discourages negative behavior among the user community—a common problem with online discussion forums—by providing users the ability to report such behavior, and taking punitive action against abusive users based on those reports.

The matching system determines which pairs of users are potentially compatible for a relationship by comparing the information in their respective profiles. This determination takes into consideration a variety of matching criterion including gender preferences, geographic location, and age. While this type of profile matching is well known in the prior art, the present invention integrates the matching results with the online discussion forums to inform each user about which other users they are potentially compatible with. Hence, a user can make an informed decision about which other users they wish to pursue relationships with based upon both the matching system's profile analysis, and their opinions formed through participation in the discussion forums.

Users can have extended online group discussions on topics of importance to them—all with the anonymity, safety, and ease of online communications—prior to ever considering a face-to-face meeting. The give and take nature of these conversations increases familiarity and intimacy. One study found that people who met after discussing an article online rated their meeting offline as more enjoyable than those who bypassed the online exchange (Ben-Ze've, 2004). Communicating for long periods of time before meeting offline also increases the chances of a couple staying together once the relationship goes offine.

In a way, discussion-based matching takes us back to more traditional times when people spent more time getting to know each other before dating one another. In fact, getting to know one another online first has advantages. As Aaron Ben-Ze'ev (2004) put it: “It seems that romantic relationships that emerge after getting to know each other are more likely to endure than those that begin as a result of mutual physical attraction. This is because the characteristics such as kindness, sensitivity, sense of humor, good manners, and wisdom revealed during the process of getting to know each other are more important for enduring love than those observed by vision i.e. physical traits.” Further, he adds that: “The fact that the intensity of our love can increase as we come to know the other person better indicates that love consists more than just physical attraction. Profound love emerges only after we nurture and develop it. Online romantic attraction is often a by product of enjoyable friendly conversation.”

Objects and Advantages

Accordingly, a number of the objects and advantages of the present invention are:
1) Potential matches are not based solely on personal profile information, instead they are based on a combination of both the profile information, and the observed characteristics of potential matches as they participate in the discussion forum. Hence, the free form text or voice portions of personal profiles becomes much less important, and even may be skipped entirely, because in the discussion based format, users will get to know each other through interactive and ongoing dialog rather than relying on prerecorded or written messages. Users are more likely to open up and reveal meaningful details about themselves in this format.
2) The discussion forums provide users with a pressure-free environment, within which to interact and learn about each other without any requirement that they reveal their potential interest in each other. They can simply be there to enjoy and participate in the discussion, without having to make quick decisions about whether or not to pursue or accept a relationship with another user.
3) When a user does decide to initiate contact with another user for the purpose of starting a relationship, they will be communicating with someone whom they have had opportunities to interact with in the discussion forums. Hence, the contact is made between two people who are acquaintances from the discussion forum rather than between two strangers who have never communicated before. This encourages more contacts to occur, and improves the chances that a given contact will result in a successful relationship.
4) The discussion forums allow prospective partners to observe each other in a social setting to see how he or she behaves around others. This more closely simulates the way relationships are typically formed in the “offline” world, where two people are able to observe their prospective match in a variety of situations prior to pursuing a relationship. Also, people who do participate in online communication report falling in love faster, and deeper online. As Aaron Ben-Ze'ev (2004) put it: “Getting to know each other online is considered to be an almost spiritual enterprise in which a deeper and purer kind of interaction takes place. Despite spatial separation, everything is close in cyberspace, everywhere is just a typing space away. So you may feel as if you are in the same room.”
5) The perception of going “shopping” for a potential match is greatly reduced. In discussion-based matching, users do not simply conduct a search and go through page after page of user listings, as if shopping in a catalog. Instead users locate potential matches by participating in the discussion forums and getting to know potential matches on a more personal level. By the time one of them does decide to initiate an offline relationship, they may already have a well established friendship or even love for each other.
6) A person's physical appearance in their online photograph becomes a less important factor in pursuing a relationship. In online communication forums, the emphasis is on personal characteristics rather than external appearance. Physical beauty may give rise to a phenomenon described as an “attractiveness halo” (Aaron Ben-Ze'ev 2004), where others assume a beautiful person will have other positive characteristics as well. These perceptions are not always accurate, and are unfair to those who are not blessed with good looks. In an online discussion-based dating community, the “attractiveness halo” will be replaced with a “personality halo”. A person who has positive personality traits will be assumed to possess other good characteristics, sometimes even those connected to external appearance. In a study of online relationships, many respondents who met their partners in person say that when they got to know one another's personal (inner) characteristics first, external physical characteristics did not matter as much (Ben-Ze'ev, 2004). Even so, not all first dates will be a success, but they will certainly start off in the best circumstances possible.
7) The addition of online discussion forums adds an interactive content component to the matching service that makes using the service enjoyable, even at times when one is not looking for a date. It provides a pressure free setting where users can engage in subjects that interest them, while at the same time, having the added benefit of meeting others who you may become attracted to, and develop long term online—and later offline—relationships with. The user experience will be more profound, and enjoyable than going through pages and pages of user profiles, or taking psychological tests.

There are additional objects and advantages, when compared with typical online discussion forums that are not operated as matching services:
1) Unlike typical discussion forums, the matching system discussion forums are integrated with user profile information to inform users of which participants are also potential relationship matches.
2) The user community participating in the discussion-based matching service will consist of members who by definition are interested in finding new personal relationships. This greatly increases the chances of successfully forming a new relationship when contacting another user as compared with contacting another user in a typical discussion forum.
3) The matching system provides a novel behavior reporting mechanism that discourages negative behavior of so called “trolls”, controlling personalities, sycophants, and otherwise abusive users. Still further objects and advantages will become apparent from a consideration of the ensuing description and drawings.

### BRIEF DESCRIPTION OF THE DRAWINGS

FIG. 1 is a block diagram overview of the discussion-based relationship matching system.

FIG. 2 is an exemplary graphical user interface for registering a user and collecting profile information.

FIG. 3 is an exemplary graphical user interface for displaying a list of discussion topics.

FIG. 4 is an exemplary graphical user interface for displaying a single topic and list of comments relating to that topic.

FIG. 5 is an exemplary graphical user interface for displaying the profile, discussion forum history, and relationship compatibility of a user of the matching system.

FIG. 6 is an exemplary graphical user interface for collecting a report regarding a user's online behavior.

FIG. 7 illustrates the stages of processing a user in the matching system.

FIG. 8 is a flow chart diagram illustrating an exemplary set of processing steps for displaying a set of topics to a user of the matching system.

FIGS. 9A-C are flow chart diagrams illustrating an exemplary set of processing steps for collecting user behavior reports, displaying a type of “abusive user icon” next to a username, and displaying a list of users that have been categorized as abusive.

### DETAILED DESCRIPTION OF THE INVENTION

The present invention relates to functions and operations of an online matching service that assists users in forming romantic and/or friendship relationships with each other. The matching service registers users and keeps a database of user profiles that include personal information, personality testing results, and relationship preferences and criteria of each user. The matching service provides online discussion forums for group-based communication among its users, so that a user may interact with the community of users prior to making decisions regarding who they wish to pursue relationships with. As a user interacts in the discussion forums, the matching service provides information to the user indicating what other users are potential relationship matches, according to the previously recorded profile information of both users.

In the preferred embodiment of the invention a plurality of discussion forums is provided covering a wide range of topic areas, such as but not limited to politics, outdoors, hobbies, news, sports, religion, travel, and music. For a hobby or professional interest such as photography, the matching system provides ways to post topics that consist of images and descriptive text. Users can then post critiques including a numerical value on a rating scale which indicates their opinion of the image quality. This gives users a chance to discuss pictures taken by members and form friendships based on shared interests. Within each forum, topics are posted either by users or by the service administrators. Users first log in to the matching system, and can then view the forums and submit new discussion topics, or comments associated with an existing topic. Their comments are displayed to other users when the other users view the associated topic. The user's username is displayed in association with any topic or comment that the user submitted. Users can also perform searches of past topics and comments, look through “quotables”—memorable sentences taken out of individual topics or comments. Users may also maintain a list of other users who are their personal favorites and friends.

Informing Users of Potential Relationship Matches

When the matching system displays topics or comments to a given logged in user, it customizes the display to show which other usernames are compatible relationship matches. This is accomplished by rendering a series of “compatibility icons” next to the usemames of users that the matching system has determined are potential relationship matches. The matching system makes the relationship match determination by comparing the profile of the logged in user with the profile of the user who submitted the topic or comment being displayed. For example, if user A has posted a comment into the forum, and user B is viewing the posted comments, and the matching system determines that user A and user B are a potential relationship match, then the matching system shall present on user B's display an icon, appearing next to A's username, which indicates that user A is a potential relationship match. At the same time, if user B and user C are found to be not compatible, then no icon will be displayed next to user C's username on user B's display, or vice versa.

In another embodiment, the compatibility icon may be presented as a rating, showing how compatible the other user is, perhaps on a scale such as 1 to 10, using a color-coding system, or by presenting one icon from a plurality of icons that represent the “strength scale” for potential matches. The compatibility icons may be replaced or enhanced by text, color, graphics, sounds, or video. The display of the usernames may also be altered, in various ways, for example by displaying them in different colors, sizes, or fonts, according to the compatibility ranking.

In yet another embodiment, the display of usernames is not altered or enhanced in any way. Instead, a separate element in the graphical user interface, such as separate list or pop-up window shows which users are potential relationship matches.

In another embodiment, the matching system does not render any indication of relationship compatibility within the discussion forums, but still allows a logged in user to determine whether there is a relationship match with other users by clicking on usernames to view user profiles, or by searching for relationship matches via a database query. When a profile of another user is viewed, the matching system automatically indicates whether there is a relationship match, based on the information in the profiles of the logged in user and the user being viewed.

Controlling Abusive Users

The matching system provides a discussion forums that are user friendly for a vast majority of the user population by employing a new technique to discourage so called “trolls”, bad language, controlling type personalities, sycophants, and otherwise abusive users. This is accomplished by giving each participant an opportunity to report on the online behavior of other users. In the preferred embodiment, this allows the user to press a button associated with a given comment or posting of another user for the purpose of submitting a report on that user's behavior. The reporting user can then classify the behavior using a number of categories such as offensive, insincere, etc.

The system counts the total number of negative reports submitted on an individual user and if it goes over a threshold limit, then the user community will be informed of that person's behavioral pattern. In the preferred embodiment this involves publicly displaying on the service's home page a list of such users, including an indication of the dominant type of behavior other users have reported about them. An icon is also displayed next to a user's username indicating the type of behavior the user has been most frequently reported for.

As one way to safeguard the reporting system from being abused, each report is stored with the reporting user's network address, such as their IP address on the Internet, and their username. Multiple reports coming from an individual usemame, or network address are subject to scrutiny by the service administrators, who can make a determination about the sincerity of the reporting user. The administrators have the option to remove any reports they deem as invalid, and can also block a given user or network address from submitting further reports.

Since no one wants to be labeled a sycophant, a troll, control freak, or verbal abuser, the community of users is largely self-policed. People who make the list of abusive users repeatedly can be warned and ultimately banned from the service.

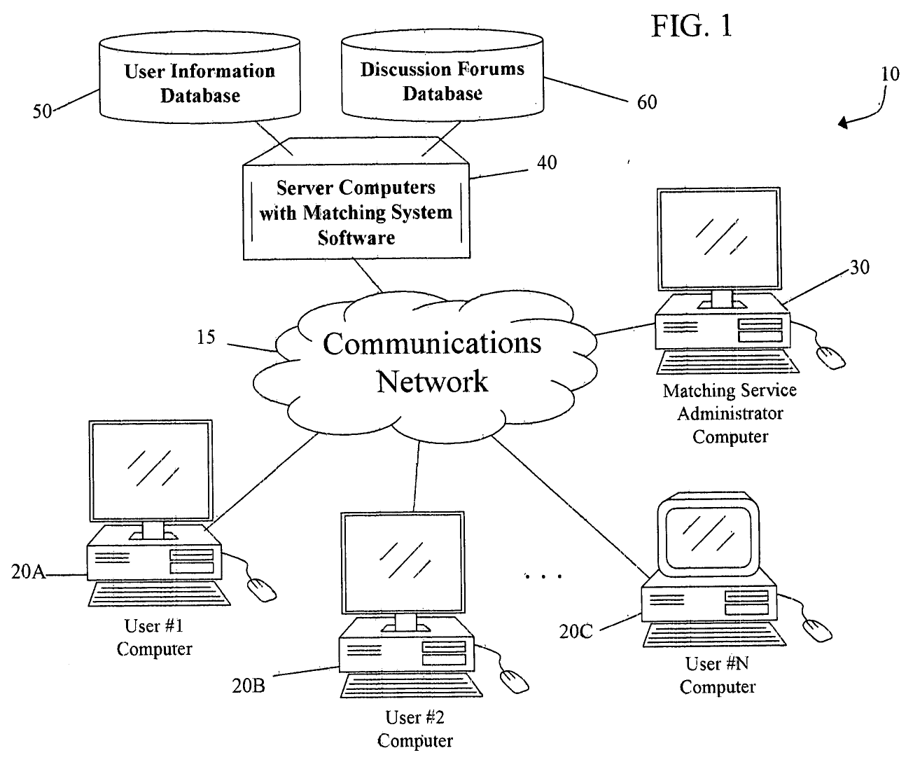

Matching System High Level Overview—FIG. 1

FIG. 1 illustrates an embodiment of a matching system 10 for matching users who are interesting in establishing romantic and/or friendship relationships with each other. The system 10 includes a communications network 15, providing communication between a matching service server computer 40, one or more matching service administrator computers 30, and a plurality of user computers 20A-C. The matching service server computer 40 can include one or more processing elements, one or more user information databases 50, and one or more discussion forum databases 60. Suitable user computer units 20A-C include, but limited to, desktop personal computers, personal digital assistants (PDAs), laptops, cell phones, tablet computers, Internet-enabled televisions, or any other device capable of interfacing with a communications network. Suitable communication networks 15 include, but are not limited to, the Internet, an intranet, an extranet, a virtual private network (VPN), and non-TCP/IP based networks.

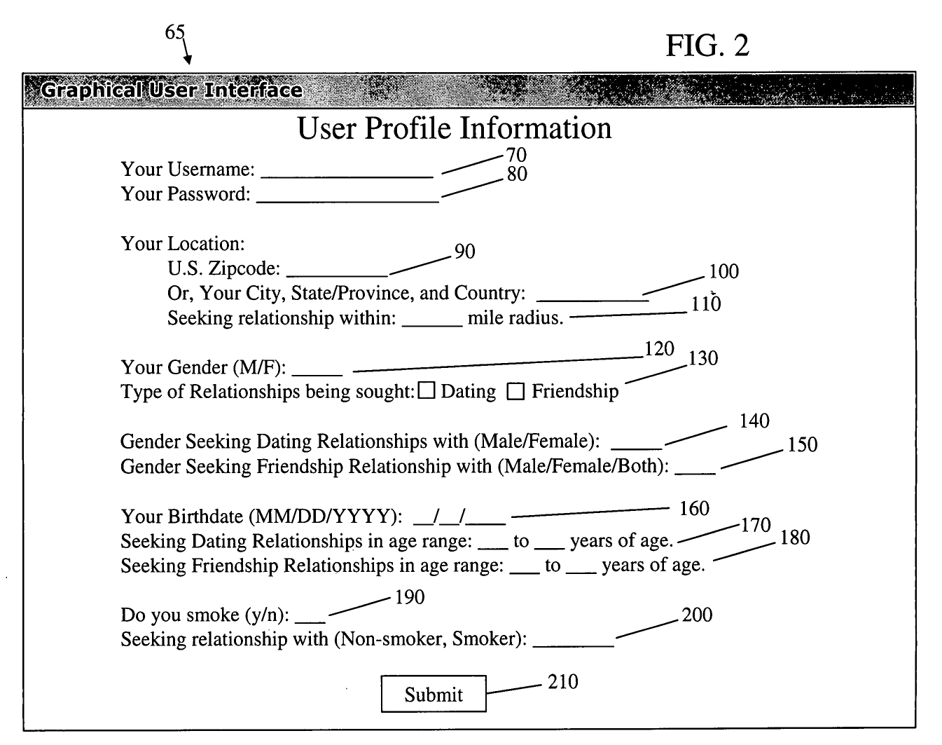

Exemplary Graphical User Interface—FIGS. 2-6

FIG. 2 illustrates an exemplary graphical user interface 65 for registration of a matching system user, and for collection of profile information. Profile information includes, but not limited to, a username 70, a password 80, location information comprising a U.S. zip code 90, or a city, state/province, and country 100, gender 120, birth date 160, and status as a tobacco smoker 190, as well as relationship preferences including, but not limited to, types of relationships sought 130, gender of persons for whom dating 140, and friendship 150 relationships are sought, age range of persons for whom dating 170, and friendship 180 relationships are sought, and smoking status 200 of persons for whom relationships are sought. The graphical user interface 65 provides a means by which the user can submit 210 their information to the matching system. The profile information shown in FIG. 2 is exemplary and the invention is not to be limited thereto. More and less criteria, characteristic, and preference data elements can be used. For example, the user can interactively take surveys, such as psychological tests, that yield discrete results to be stored as part of the user's profile for the purpose of using it in determining match compatibility with other users. Other personal information, such as a photograph, voice or video recording, essays about themselves or what they are seeking in relationships, can also be stored as part of the user profile, and accessed by other users.

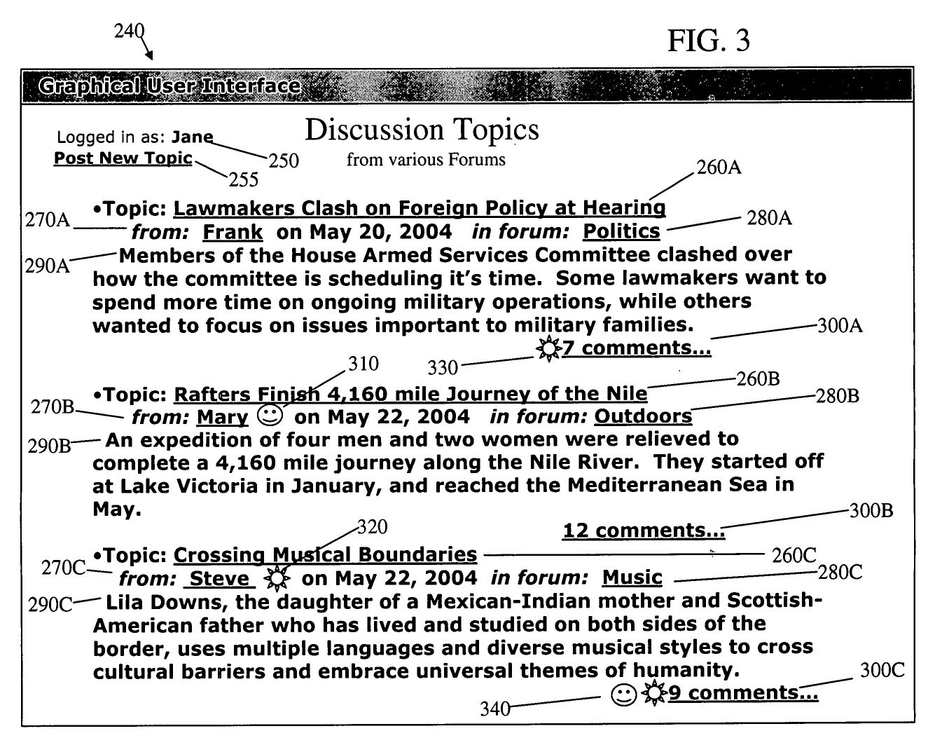

FIG. 3 illustrates an exemplary graphical user interface 240 to the discussion forums. As shown, a user 250 is logged in to the matching system, and is viewing a number of topics 260A-C, from various forums 280A-C. The usernames 270A-C of the users who submitted the topics are shown, as are the texts 290A-C of the topics. For each topic, an indication 300A-C is provided as to how many comments have been submitted regarding that topic. The logged in user may click on any topic name 260A-C, or any comment indicator 300A-C to go to another interface, which will show the topic and comments in detail. The logged in user may click on any displayed username to view profile information and discussion forum history of that user, including an analysis of whether that user is a compatible relationship match with the logged in user. The user also is provided with the option 255 to post a new topic for discussion.

For each username displayed 270A-C, the matching system determines if there is a relationship match between the logged in user and the username being displayed. Wherever relationship matches are found, compatibility icons are displayed to inform the logged in user of these matches. For example, username Mary 270B is found to be compatible for a friendship relationship with the logged in user Jane 250. Hence, a compatibility icon for friendship 310 is shown next to Mary's username 270B. Likewise, username Steve 270C is found to be compatible for a romantic relationship with Jane 250, and a compatibility icon for dating 320 is shown next to Steve's username 270C.

Furthermore, it may be that the user who posted a topic is not a compatible match, but someone who posted a comment for the topic is a match. In this case it is desirable to inform the logged in user that one of the comments may be of interest since it was submitted to someone who is a match. In this case a compatibility icon is displayed next to the comments indicator 300A-C. For example, username Frank 270A is not a compatible match for Jane 250, however someone who posted a comment to Frank's topic is a match for a dating relationship. Therefore, the dating icon 330 is shown next to the comments indicator for Frank's topic 300A. In a similar fashion, both friendship and dating icons 340 are shown next to the comments indicator for Steve's topic 300C. By clicking on the comment link, the user can display all the comments to discover who the potential relationship match is, and may then read that user's comment.

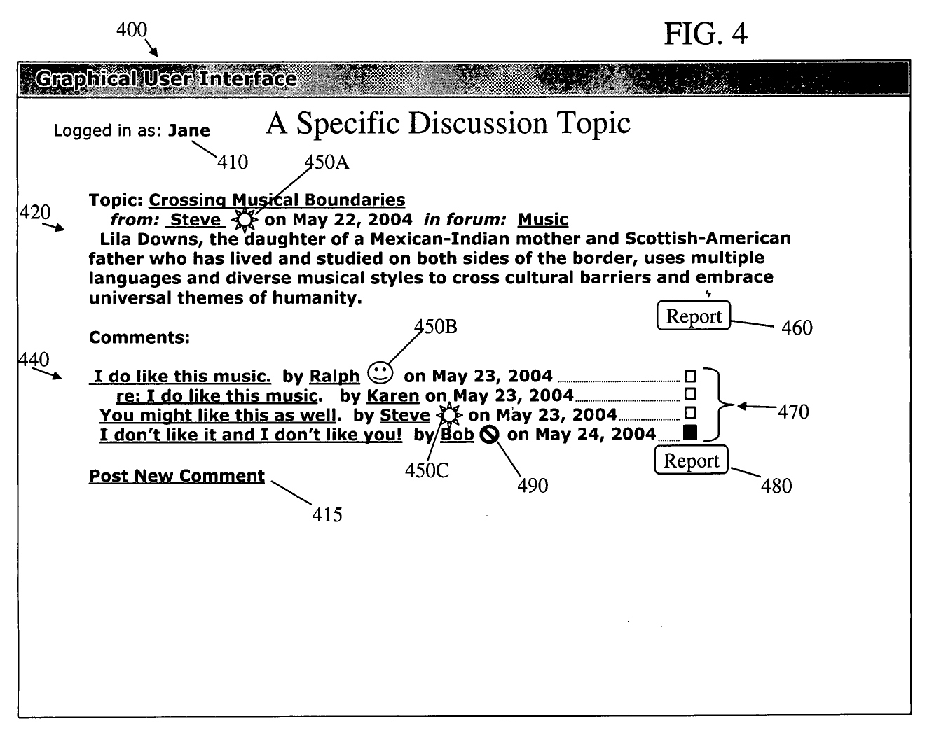

FIG. 4 illustrates an exemplary graphical user interface 400 for viewing a specific topic and its associated comments. The username of the logged in user 410 is displayed, along with the topic 420 and the various comments that have been submitted 440. As with FIG. 3, compatibility icons 450A-C are displayed next to each username that the matching system determines is a compatible match with the logged in user. If the user sees that another user is exhibiting bad behavior, then a report can be submitted by clicking a associated checkbox 470 and pressing a “report button” 480. They can also report on the topic contents using a second “report button” located just under the topic text 460. Users who have been flagged by the system as being abusive users, will have a special “abusive user icon” 490 placed next to their username. The specific icon can be selected from a set of icons based on the type of behavior the user has been most reported for. Finally, the logged in user is also provided with a means for posting an additional comment 415 related to this topic.

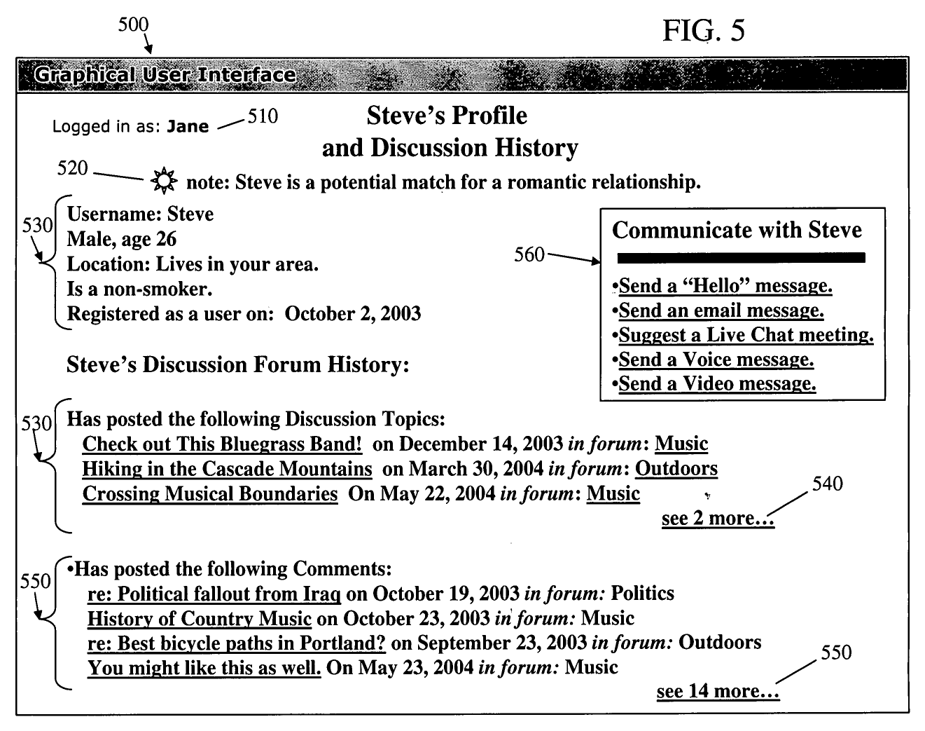

FIG. 5 illustrates an exemplary graphical user interface 500 for viewing a user's profile and discussion forum history. The username of the logged in user 510 is displayed, along with an indication of the result of relationship matching 520 between the logged in user and the user being displayed. Personal information about the user 530 is displayed, as well as lists of the most recent topics 530, and most recent comments 550, the user has submitted to the matching system. If there are additional topics submitted by this user, but not displayed on this interface, then an indication of additional topics is shown 540. Likewise, an indication of additional comments is shown 550.

The logged in user can click on any topic to view that topic in detail, along with any comments as previously shown in FIG. 4. The user may click on the indications of more topics 540, or more comments 550 to view the additional topics or comments. The user can also choose from a number of methods 560 for privately communicating with the user being viewed, including but not limited to, sending a short “hello” text message, sending an email, proposing a time to meet online for a live chat.

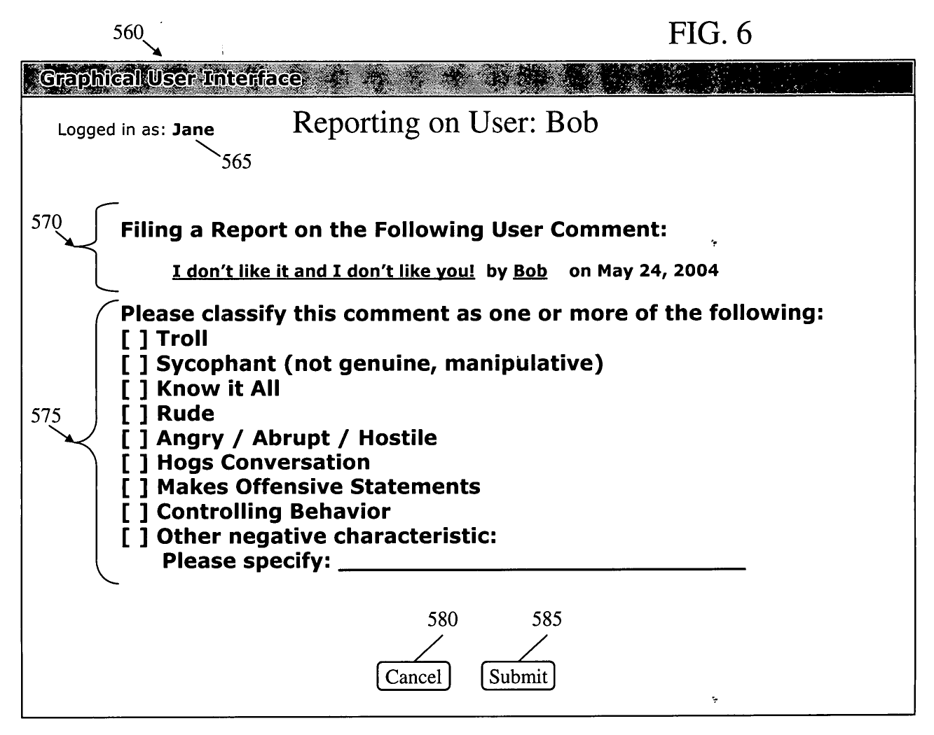

FIG. 6 illustrates an exemplary graphical user interface 560 for one user submitting a report regarding a second user's online behavior in the discussion forum. The username of the logged in user 565 who is submitting the report is displayed. Information about the user comment being reported is also displayed 570. The logged in user classifies the behavior by selecting from one or more check boxes 575. Finally, the logged in user can either go ahead and submit the report 585, or choose to cancel 580 the report.

Suitable implementations of the exemplary graphical user interfaces shown in FIGS. 2-6 include, but are not limited to, web browser interfaces, Java interfaces, and any other interfaces implemented in a computer programming or specification language.

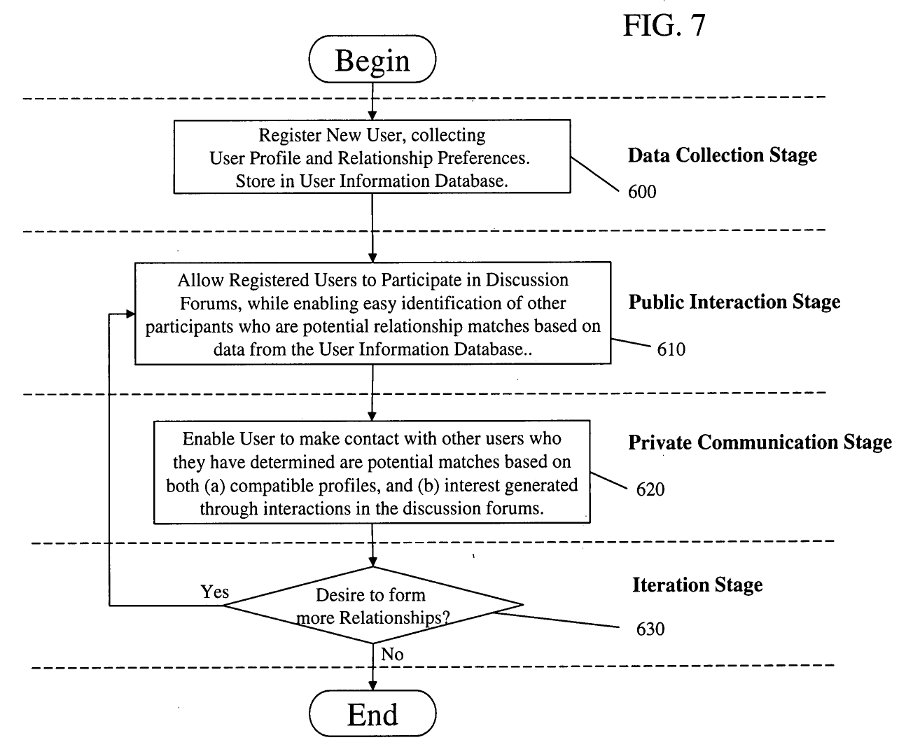

Operation Flowcharts—FIGS. 7, 8, 9A-C

FIG. 7 shows the overall stages of discussion-based relationship matching. First, in the Data Collection Stage 600, a new user registers with the system and provides profile and relationship preference information, which is stored in a user information database. Next, in the Public Interaction Stage 610, users interact with each other, learning about each other and determining which eligible participants they are most interested in pursuing relationships with. Next comes the Private Communication Stage 620, where the matching system enables users to communicate with each other privately for the purpose of pursing relationships. Finally, in the Iteration Stage 630, a user determines if they would like to form more relationships, and if so, they return to the Public Interaction Stage 610. A given user can have multiple simultaneous communication interactions ongoing in both the Public Interaction Stage 610, and the Private Communication Stage 620.

While numerous implementation aspects of the matching system will be familiar with those skilled in the art of software development, and in particular Internet-based web site development, there are aspects of the invention that are novel and require further detailed explanation. The displaying of compatibility icons is one such aspect of the invention. The exact set of icons displayed will often be different for every user logged into the matching system. Users A and B may be looking at the exact same discussion forum, but user A may see no compatibility icons, while user B sees compatibility icons for numerous usernames.

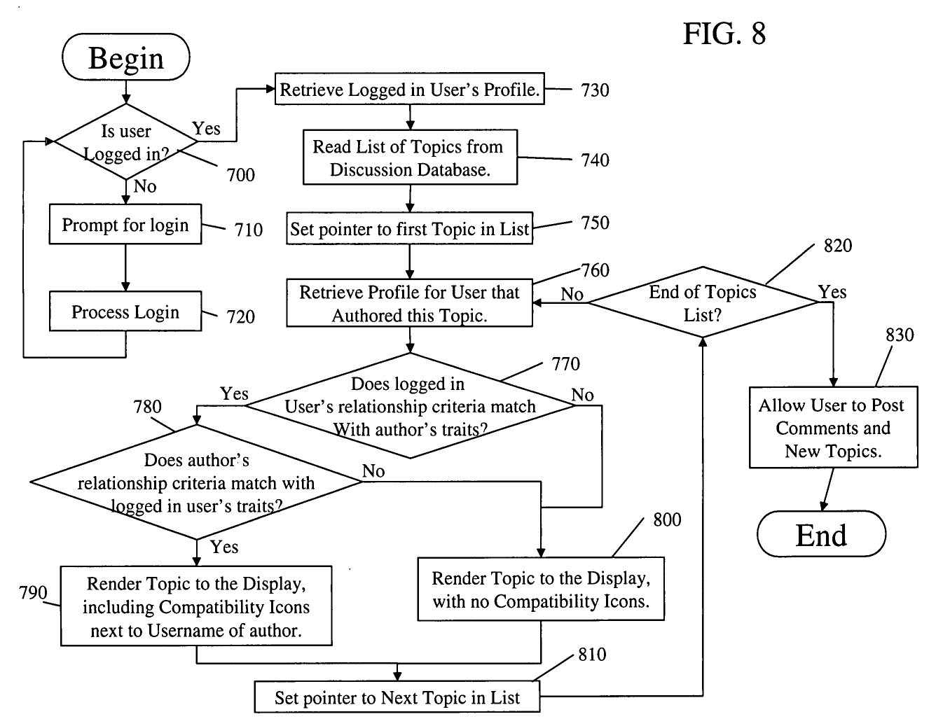

FIG. 8 provides a flow chart diagram defining a sequence of processing steps for the display of compatibility icons. The sequence begins with a decision 700 as to whether the user accessing the system is properly logged in. If the user is not logged in, the system prompts the user to log in 710. When the user responds, the login request is processed 720. The logged in decision 700 is made again, and if the login was a success, the sequence proceeds to retrieving the logged in user's profile 730.

Next, the system reads a list of topics to be displayed to the user from the discussion forum database 740. An internal pointer is set to the first topic in the retrieved list 750. The profile of the user who authored the currently pointed to topic is then retrieved from the user information database 760. This author's traits are then compared with the relationship criteria from the profile of the logged in user, to find out if they match 770. If they do, then the author's relationship criteria are compared with the traits of the logged in user 780. If this comparison matches as well, then the topic is displayed with the compatibility icons shown next to the author's username 790. If the match failed in either direction, then the topic is displayed without any compatibility icons 800.

Next, the pointer into the list of retrieved topics is advanced 810. If there is another topic to be processed 820, then processing returns to retrieval of the author's profile 760. Otherwise if the end of the list of topics is reached, then the logged in user's display will show a list of topics, and the user is provided with options 830 to post a new topic, comment on an existing topic, or do other navigate to other parts of the system, such as clicking on a username to view a user's profile. Then the processing sequence ends.

In another embodiment of the invention, the determination of compatible users may be made ahead of time, and the results consulted for the purpose of generating the topic forum display. In yet other embodiments, the indications of compatible users may take many forms including the use of color, graphics, sounds, text, or video. Alternatively the usernames may be displayed in a different order, for example with compatible users towards the top of the display, followed by incompatible users, or the incompatible users may not be displayed at all.

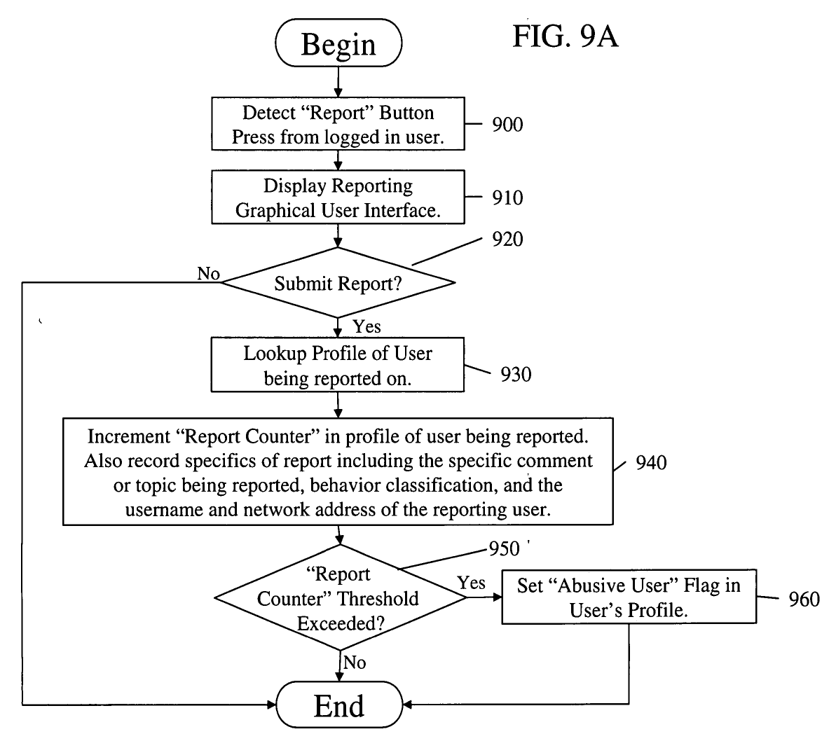

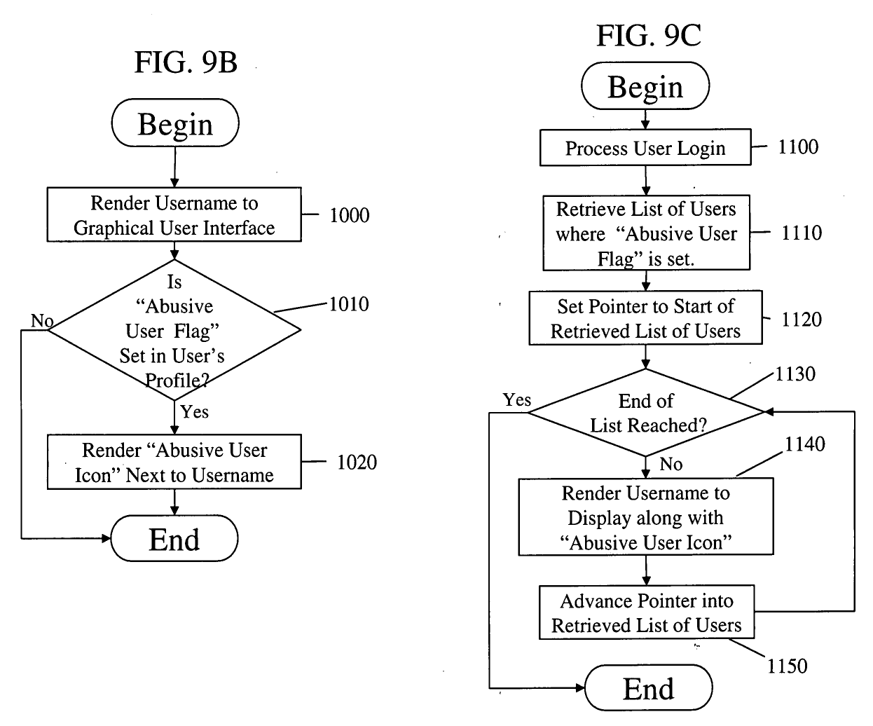

Another novel aspect of the invention that deserves detailed description is the abusive user reporting mechanism. FIGS. 9A-C detail the processing steps for implementing this capability.

FIG. 9A provides a flow chart defining a sequence of processing steps for allowing a logged in user to submit a report regarding the online behavior of a second user. In the first step 900 the system detects that the logged in user has pressed a “report” button. In the next step 910 the system then displays a reporting graphical user interface, such as that previously shown in FIG. 6. A decision 920 determines if the user has chosen to submit the report by pressing a submit button. If so, then the system performs a next step 930 where it retrieves the profile of the user being reported on, and a subsequent step 940 where it increments a “report counter” value in the retrieved profile data record, and stores details of the report into a system database. The report details include the comment or topic being reported on, the behavior classification assigned by the reporting user, and the username and network address of the reporting user. Next, a decision 950 determines if the “report counter” value, having been incremented in the previous step, now exceeds a system predefined threshold value. If it does then a next step 960 sets the “abusive user flag” in the reported on user's profile record. Service administrators can later use the detailed information recorded about the report to determine if the reporting user is abusing the reporting system by submitting reports that are not justified.

FIG. 9B shows a flow chart diagram illustrating a sequence of processing steps to be used when rendering usernames in parts of the system where it is desirable to show an “abusive user icon” next to the username of a user who has the “abusive user flag” set in their profile data. The sequence begins with rendering the username to the display 1000. Next, if the “abusive user flag” is set in said user's profile data 1010, then the “abusive user icon” is rendered next to the username 1020.

FIG. 9C shows a flow chart diagram illustrating a set of processing steps to be executed when any user logs in to the matching system. The sequence begins with normally processing the user's login request 1100. Next, a list of user profiles is retrieved, consisting of all user profiles where the “abusive user flag” is set 1110. A pointer is set to point at the first element of said list 1120, or at an end of list indicator if said list is empty. Next, if the end of the list has not been reached 1130, then the username in the profile being pointed to, along with an “abusive user icon”, is rendered to the display of the user who is logging in 1140. Next the pointer into the list of users is advanced 1150, and processing returns to the decision testing for the end of the list being reached 1130. When the end of the list is reached, the processing sequence terminates. Hence, the list of abusive users is reported to any user who is logging in.

Additional Alternative Embodiments

An alternative embodiment is to execute the algorithm described in FIG. 9C when a user merely brings up the matching service home page, without requiring the login step.

In another embodiment of the invention, different icons are displayed next to abusive users, depending on what type of behavior has been reported about them. So, users with a majority of “angry” reports have an icon of an angry facial expression next to their username, while users with a majority of “rude” reports have an icon of a rude facial expression.

In yet another embodiment of the invention, the user reporting mechanism is used to report other types of behavior, such as positive, helpful, or friendly behavior. Such reporting can then drive the system to classify users in any number of categories. The system then informs the user community through various means, including username icons, of the classifications that are made.

In still another embodiment, a user cannot view photographs of other users until a time period, such as three months, have elapsed from the time said user registered with the system. This is to encourage users to get to know each other first before going “shopping” based primarily on appearance.

### CONCLUSION, RAMIFICATIONS, AND SCOPE OF INVENTION

Thus the reader will see that the discussion-based matching system provides a novel and effective means for establishing romantic and/or friendship relationships that solves many problems of the prior art. Users are provided the opportunity to get to know one another online prior to initiating an offline relationship, and the matching system ensures that users know which other users they may be compatible with.

While my above description contains many specificities, these should not be construed as limitations on the scope of the invention, but rather as an exemplification of one preferred embodiment thereof. Many other variations are possible. For example variations are possible in the specific user interface, profile information, matching criteria, and communication medium.

Further, a second order matching can be implemented whereby special icons are shown for users who are not directly compatible with the logged in user, but who are compatible with a second user that the logged in user want to learn more about. Such as scheme would let the logged in user see who else are possible matches for the second user, and would allow the logged in user to determine “who the competition is” for the affections of the second user.

Or, users might determine their interest in other users by reading comments those users previously posted on some online system other than the current matching system. For example, the comments might be from an archive of an Internet Usenet newsgroup. The matching system could be programmed to incorporate those comments and display compatibility icons just as it does for the integrated discussion forums.

Accordingly, the scope of the invention should be determined not by the embodiment(s) illustrated, but by the appended claims and their legal equivalents.

What is claimed is:

1. A method of operating a relationship matching service comprising:
(a) collecting and storing information about users of the service;
(b) providing online discussion forums allowing the community of said users to interact with each other; and
(c) informing said users about potential relationship matches based on said collected and stored information.

2. The method of claim 1, wherein collecting information about said users includes collecting personal traits as well as preferences for the types of relationships they desire.

3. The method of claim 1, wherein collecting information about said users includes collecting the results of surveys from the users.

4. The method of claim 1, wherein said online discussion forums are comprised of:
(a) online databases storing topics and commentary submitted by users covering any conceivable area of interest including the group consisting of but not limited to politics, religion, hobbies, computers, art, music, and photography; and
(b) the means to display said topics and commentary at a later time upon demand from a user.

5. The method of claim 4, wherein said topics are comprised of images and descriptive text, and users submit critique commentary along with an optional numerical rating of the images that represents the quality of the images on a predefined rating scale.

6. The method of claim 1, wherein informing said users of potential relationship matches comprises displaying of visual indications on a graphical user interface.

7. The method of claim 6 wherein said visual indications are selected from a group consisting of:
graphical icons displayed near usernames, graphical animations displayed near usernames, spatial separation of usernames, different coloring of usernames, and different font characteristics of usernames.

8. The method of claim 1, wherein informing said users of potential relationship matches includes having the user view the profile information of other users.

9. The method of claim 8, wherein viewing the profile information of another includes viewing the photograph of the user being viewed only after a predetermined number of days has elapsed since the viewing user joined the matching service.

10. The method of claim 1, further comprising: providing a private communication medium between pairs of said users, where said communication medium is selected from the group consisting of real-time chat, email, system message inbox, voice messaging, voice call, and video conference.

11. A method of influencing behavior of users in multiparty communication mediums, comprising:
(c) providing a reporting mechanism that allows a user to report on the behavior of other users;
(d) recording information from said reports on individual users;
(e) analyzing said recorded information to determine if reports on an individual user have exceeded a threshold; and
(f) informing the user community of said multiparty communication medium about the users determined to have exceeded the threshold.

12. The method of claim 11, further comprising:
providing a warning to the threshold exceeding user after an initial predetermined threshold is reached, but prior to reaching a predetermined punitive threshold

13. The method of claim 11, further comprising blocking a user from accessing the communication media when the reporting count has exceeded a predetermined threshold value.

14. The method of claim 11, further comprising permitting the users who reported on a second user to later withdraw their report.

15. The method of claim 11, further comprising enabling users to enter positive feedback about other users wherein a predetermined number of positive reports submitted for a given user causes the system to display positive visual indications about said user, wherein said visual indications are selected from a group consisting of: graphical icons displayed near usernames, graphical animations displayed near usernames, different coloring of usernames, different font characteristics of usernames.

16. The method of claim 11, wherein providing a reporting mechanism includes allowing the reporting user to click on a graphical user interface element associated with the reported on user's online communication.

17. The method of claim 11, wherein informing of said user community regarding users who have exceeded the threshold is accomplished by displaying the usernames of threshold exceeding users on the service home page.

18. The method of claim 11, wherein informing of said user community regarding users who have exceeded the threshold is accomplished by displaying a visual indication in association with the threshold exceeding user's username.

19. The method of claim 11, wherein reporting feedback about a particular user is collected by means of a survey of the user community.

20. The method of claim 11, wherein the recorded information includes the network address and username of the user submitting the report.

21. A system for matching users of an online service based on their personal profile information and user interactions, comprising:
(g) computer processor means for processing data;
(h) first means for collecting information about the relevant traits of a user;
(i) second means for collecting information about preferences the user desires in relationships;
(j) third means for allowing the community of users to interact in online discussion forums;
(k) fourth means for comparing selected preferences and traits of the user with other users participating in the discussion forums to determine potential matches; and
fifth means for informing users about said potential matches.
